(19) United States
(12) Patent Application Publication
(10) Pub. No.: US 2024/0399809 A1
(43) Pub. Date: Dec. 5, 2024

(54) SHOCK ABSORBER

(71) Applicant: KYB Corporation, Tokyo (JP)

(72) Inventors: Yoshiki MATSUOKA, Tokyo (JP); Kyusuke TSUCHIDA, Tokyo (JP)

(73) Assignee: KYB Corporation, Tokyo (JP)

(21) Appl. No.: 18/693,269

(22) PCT Filed: Nov. 22, 2022
(86) PCT No.: PCT/JP2022/043110

§ 371 Date: Mar. 19, 2024

(30) Foreign Application Priority Data
Dec. 20, 2021 (JP) 2021-206239

(51) Int. Cl. B60G 13/00

(52) U.S. Cl. CPC B60G 13/001; B60G 2204/4304

(57) ABSTRACT

A shock absorber according to the present embodiment includes a shock absorber main body having a cylindrical outer shell and a rod movably inserted into the outer shell, and a knuckle bracket attached to an outer periphery of a lower end of the outer shell, in which the knuckle bracket is formed by bending a single metal plate as a base material and includes a pair of clamping pieces that are curved along the outer periphery of the outer shell and clamp the outer shell, a pair of attachment pieces that extend in a radial direction of the outer shell from ends in a circumferential direction of the respective clamping pieces and face each other, a connecting piece that connects ends of the attachment pieces, and a pair of notches that cut off the three-plane intersection point where the clamping pieces, the attachment pieces, and the connecting piece intersect.

### TECHNICAL FIELD

The present invention relates to a shock absorber.

### BACKGROUND ART

A shock absorber includes an outer shell and a rod that is movably inserted into the outer shell, and is used by being incorporated in a suspension in a vehicle, for example, to suppress the vibration of the vehicle body and the wheel. As the piston rod moves in the axial directions with respect to the outer shell, the shock absorber becomes extended and contracted, and exerts a damping force thereby.

When such a shock absorber incorporated in a suspension is used in a strut suspension, for example, a knuckle bracket, which is for attaching a knuckle for holding a wheel of a vehicle, is attached, by welding, to the bottom end of the outer shell.

As disclosed in, for example, JP 2009-216129 A, a knuckle bracket includes, for example, a cylindrical holding portion having a C-shaped cross section and that holds an outer periphery of the outer shell, a pair of attachment portions that are can be coupled to the knuckle, and that extends radially outwards, and in parallel with each other, from two respective circumferential ends of the holding portion, and reinforcing portions formed by bending respective top ends of the attachment portions in directions approaching each other.

### CITATION LIST

### Patent Literature

### Patent Literature 1: JP 2009-216129 A

### SUMMARY OF INVENTION

### Technical Problem

In the shock absorber configured as described above, since the knuckle bracket includes the holding portion that surrounds the outer periphery of the outer shell over substantially the entire periphery and the reinforcing portion that reinforces the attachment portion, there is no problem in terms of strength. However, since there are many materials forming the knuckle bracket, the material yield is poor, and the cost and weight of the shock absorber increase.

Therefore, an object of the present invention is to provide a shock absorber capable of reducing cost and weight thereof.

### Solution to Problem

In order to solve the above problems, a shock absorber of the present invention includes a shock absorber main body having a cylindrical outer shell and a rod movably inserted into the outer shell, and a knuckle bracket attached to an outer periphery of a lower end of the outer shell, in which the knuckle bracket is formed by bending a single metal plate as a base material and includes a pair of clamping pieces that are curved along an outer periphery of the outer shell and clamp the outer shell, a pair of attachment pieces that extend in a radial direction of the outer shell from ends in a circumferential direction of the respective clamping pieces and face each other, a connecting piece that connects upper ends or lower ends of the attachment pieces, and a pair of notches that cut off a three-plane intersection point where the clamping piece, the attachment piece, and the connecting piece intersect.

In addition, in the shock absorber configured as described above, even if the clamping pieces of the knuckle bracket do not surround the outer periphery of the outer shell, the knuckle bracket can be firmly fixed to the outer shell, and since the attachment pieces and the connecting piece form a box shape, the strength of the knuckle bracket can be increased to withstand the load input from the knuckle. Since the knuckle bracket includes the notches for cutting off the three-plane intersection point where the clamping pieces, the attachment pieces, and the connecting piece intersect, the knuckle bracket having high strength can be firmly fixed to the outer shell and can be molded without difficulty. Since the knuckle bracket does not include a holding portion surrounding the outer shell unlike the conventional knuckle bracket, the knuckle bracket is smaller in size than the conventional knuckle bracket. Therefore, the material required for manufacturing is reduced, and the weight is also reduced.

### BRIEF DESCRIPTION OF DRAWINGS

FIG. 1 is a side view of a shock absorber according to an embodiment.

FIG. 2 is a front view of a knuckle bracket in the shock absorber according to the embodiment.

FIG. 3 is a side view of the knuckle bracket of the shock absorber according to the embodiment.

FIG. 4 is a plan view of the knuckle bracket attached to the shock absorber according to the embodiment.

FIG. 5(a) illustrates a flat plate punched into a shape in which the knuckle bracket is developed. FIG. 5(b) illustrates a semi-finished product of a knuckle bracket in which a clamping piece and an attachment piece are molded. FIG. 5(c) illustrates a semi-finished product of a knuckle bracket after a bolt insertion hole is formed in the attachment piece.

FIG. 6 is a perspective view of a knuckle bracket according to a modification example of the embodiment.

### DESCRIPTION OF EMBODIMENTS

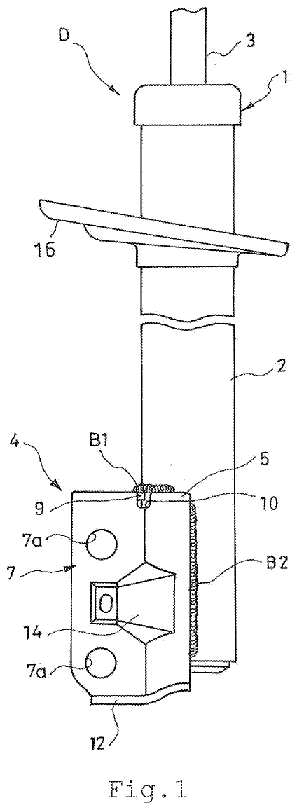

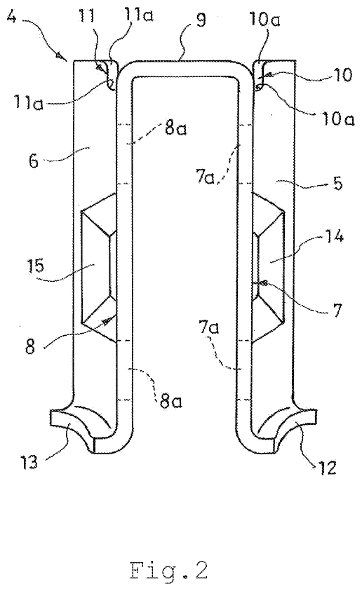

Hereinafter, the present invention will be described based on an embodiment illustrated in the drawings. As illustrated in FIGS. 1 and 2, a shock absorber D includes a shock absorber main body 1 having an outer shell 2 and a rod 3 that is movably inserted into the outer shell 2, and a knuckle bracket 4 that is attached, by welding, to an outer periphery of the bottom end of the outer shell 2, and is interposed between a vehicle body and a wheel of the vehicle by connecting the shock absorber D to a knuckle that supports the wheel, not illustrated, in the vehicle using the knuckle bracket 4.

Various parts of the shock absorber D will be described in detail below. The shock absorber main body 1 includes the cylindrical outer shell 2 and the rod 3 that is movably inserted into the outer shell 2, and dampens the vibration of the vehicle body and the wheel of the vehicle, by generating a damping force for inhibiting a relative movement of the rod 3 with respect to the outer shell 2, through an extending and contracting movement, in which the rod 3 moves relatively with respect to the outer shell 2 in the axial directions.

The shock absorber main body 1 includes, for example, the cylindrical outer shell 2 the bottom end of which is closed, a cylinder (not illustrated) that is housed inside the outer shell 2, the rod 3 that is movably inserted into the cylinder, a piston connected to the rod 3 and inserted into the cylinder to partition the internal space of the cylinder into an extension side chamber and a compression side chamber, a reservoir that is formed between the cylinder and the outer shell 2, and a valve case that is provided to the bottom end of the cylinder to provide a partition between the compression side chamber and the reservoir. The extension side chamber and the compression side chamber are filled with a liquid such as hydraulic oil, and the reservoir is filled with liquid and gas. Note that a liquid other than hydraulic oil such as water and an aqueous solution may also be used as the liquid used in the shock absorber D. Note that the outer shell 2 is a member forming the outermost shell of the shock absorber main body 1 to which the knuckle bracket 4 is attached, and may be a member that covers the rod instead of accommodating a cylinder or the like in a case where the shock absorber main body 1 is set as an inverted type.

In the piston, damping valves are provided inside a passage where the extension side chamber communicates with the compression side chamber, and in a passage where the compression side chamber communicates with the reservoir, respectively. In the shock absorber main body 1 having the configuration described above, during its extending and contracting movement, the extension side chamber and the compression side chamber are expanded and compressed by the piston, and the liquid moves through the passages. The damping valve generates a damping force by resisting the liquid flow.

Note that a lower suspension spring seat 16 supporting the bottom end of a suspension spring, not illustrated, is mounted on of the middle of the outer periphery of the outer shell 2. This suspension spring not illustrated is interposed between the upper suspension spring bearing mounted on the tip end of the rod 3 and the lower suspension spring seat 16 described above, and, when the shock absorber D is interposed between the vehicle body and the wheel, the shock absorber D supports the vehicle body elastically.

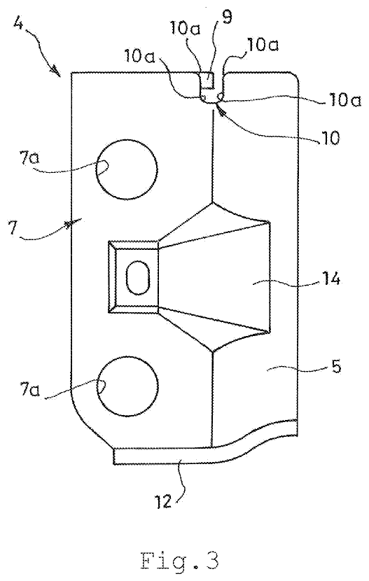

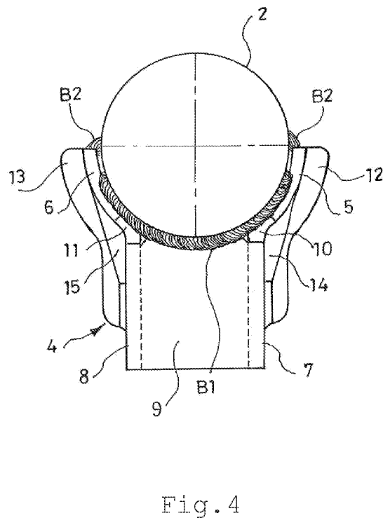

As illustrated in FIGS. 1 to 4, the knuckle bracket 4 is formed by forming a single metal plate as a base material, punching the base material into a developed shape of the knuckle bracket 4, and then bending the base material. The knuckle bracket 4 includes a pair of clamping pieces 5 and 6 that are curved along the outer periphery of the outer shell 2 and clamp the outer shell 2, a pair of attachment pieces 7 and 8 that extend in the radial direction of the outer shell 2 from the ends in the circumferential direction of the clamping pieces 5 and 6 and face each other, a connecting piece 9 that connects the ends of the attachment pieces 7 and 8, and a pair of notches 10 and 11 that cut off a three-plane intersection point where the clamping pieces 5 and 6, the attachment pieces 7 and 8, and the connecting piece 9 intersect.

Each of the clamping pieces 5 and 6 is a plate curved along the outer peripheral shape of the lower end of the outer shell 2 as viewed from the axial direction of the outer shell 2, and abuts on the inner peripheral side surface along the axial direction of the outer shell 2 as viewed from the side of the outer shell 2.

The tip ends of the clamping pieces 5 and 6, which are opposite attachment piece side ends in the circumferential direction, do not exceed a half of the outer shell 2 as viewed from the axial direction of the outer shell 2. As described above, since the tip ends of the clamping pieces 5 and 6, which are opposite attachment piece side ends in the circumferential direction, do not exceed a half of the outer shell 2 as viewed from the axial direction of the outer shell 2, when the knuckle bracket 4 abuts on the outer periphery of the lower end of the outer shell 2 in order to weld the knuckle bracket 4 to the outer periphery of the outer shell 2, the knuckle bracket 4 may be brought close to the outer shell 2 from the side, so that the assembly work is facilitated.

In addition, the attachment pieces 7 and 8 extend in parallel to each other in the radial direction of the outer shell 2 from the proximal ends in the circumferential direction of the clamping pieces 5 and 6 and face each other, and two bolt insertion holes 7a and 8a are provided at positions capable of facing two holes provided in the attachment portion of the knuckle (not illustrated). Then, the attachment portion of the knuckle (not illustrated) is inserted between the attachment pieces 7 and 8, and the attachment pieces 7 and 8 and the attachment portion are bolted by a bolt and a nut (not illustrated) penetrating the attachment portion of the knuckle inserted into the bolt insertion holes 7a and 8a, so that the knuckle bracket 4 can be attached to the knuckle.

The lower ends of the attachment piece 7 and the clamping piece 5 and the lower ends of the attachment piece 8 and the clamping piece 6 are bent outward to be away from the outer shell 2, and are provided with flange-shaped reinforcing ribs 12 and 13. Furthermore, a bulge portion 14 that is chipped from the center of the attachment piece 7 in the vertical direction to the center of the clamping piece 5 in the vertical direction and bulges away from the outer shell 2 is provided, and a bulge portion 15 that is chipped from the center of the attachment piece 8 in the vertical direction to the center of the clamping piece 6 in the vertical direction and bulges away from the outer shell 2 is provided. The reinforcing ribs 12 and 13 and the bulge portions 14 and 15 are provided to improve strength against a load that deforms the knuckle bracket 4.

The upper ends of the attachment pieces 7 and 8 are connected to each other by the connecting piece 9 perpendicular to the attachment pieces 7 and 8. A side surface of the connecting piece 9 facing the clamping pieces 5 and 6 and facing the outer peripheral surface of the outer shell 2 is curved along the outer periphery of the outer shell 2, and when the clamping pieces 5 and 6 abut on the outer periphery of the outer shell 2, the side surface of the connecting piece 9 also abuts on the outer periphery of the outer shell 2. As described above, in the knuckle bracket 4, the attachment pieces 7 and 8 and the connecting piece 9 have a box shape, and the proximal ends of the attachment pieces 7 and 8 are connected to the clamping pieces 5 and 6, respectively.

In addition, the knuckle bracket 4 includes the notches 10 and 11 at an upper end of a boundary between the clamping piece 5 and the attachment piece 7 and an upper end of a boundary between the clamping piece 6 and the attachment piece 8, respectively. The notch 10 is provided to cut off a three-plane intersection point which is an intersection point of three surfaces of the clamping piece 5, the attachment piece 7, and the connecting piece 9, and the notch 11 is provided to cut off a three-plane intersection point which is an intersection point of three surfaces of the clamping piece 6, the attachment piece 8, and the connecting piece 9. The notches 10 and 11 are provided to be cut across three surfaces of the clamping piece 5, the attachment piece 7, and the connecting piece 9 including the three-plane intersection points. In addition, since the notches 10 and 11 may be provided so as not to form a three-plane intersection point where the clamping piece 6, the attachment piece 8, and the connecting piece 9 intersect in the knuckle bracket 4, the notches may be provided over any two adjacent surfaces among the three surfaces of the clamping piece 5, the attachment piece 7, and the connecting piece 9 to be in contact with the remaining one surface, or the notches may be provided on any one of the three surfaces of the clamping piece 5, the attachment piece 7, and the connecting piece 9 to be in contact with at least one of the remaining two surfaces.

Each of the notches 10 and 11 is opened from an upper end of a boundary between the clamping pieces 5 and 6, the attachment pieces 7 and 8, and the connecting piece 9 and is formed by cutting a base material downward into a rectangular shape, and includes chamfered portions 10a and 11a formed by chamfering four corner portions in an R shape.

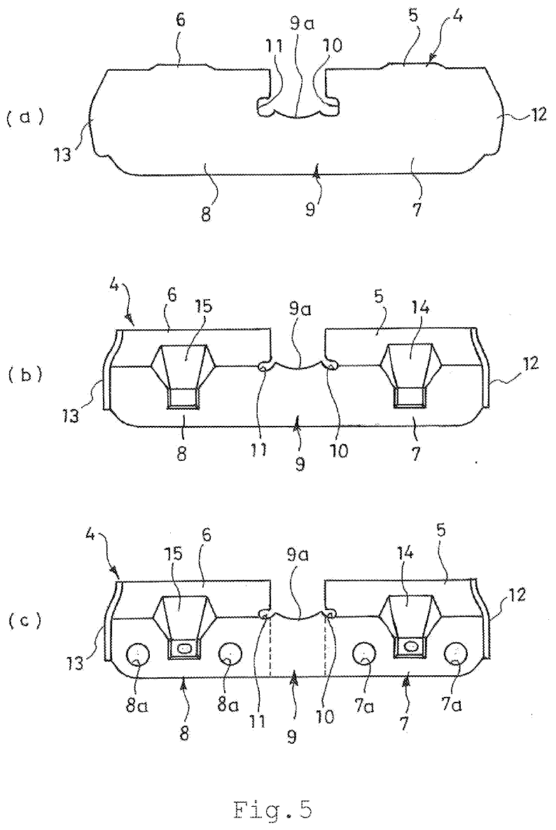

The knuckle bracket 4 configured as described above is manufactured by the following procedure. First, a base material of a rectangular metal flat plate-like blank (not illustrated) is punched to obtain a flat plate having a shape in which the knuckle bracket 4 illustrated in FIG. 5(a) is developed. Subsequently, the flat plate is bent and molded by press working to mold the clamping pieces 5 and 6, the attachment pieces 7 and 8, the reinforcing ribs 12 and 13, and the bulge portions 14 and 15 as illustrated in FIG. 5(b), and then the bolt insertion holes 7a and 8a are punched into the attachment pieces 7 and 8 as illustrated in FIG. 5(c). When bending processing of bending the semi-finished product of the knuckle bracket 4, which has been drilled in FIG. 5(c), is performed with a broken line in FIG. 5(c), the connecting piece 9 and the attachment pieces 7 and 8 are bent at a right angle, and the knuckle bracket 4 can be manufactured.

Although the knuckle bracket 4 is manufactured in this manner, the two three-plane intersection points of the clamping pieces 5 and 6, the attachment pieces 7 and 8, and the connecting piece 9 are cut off by the notches 10 and 11, respectively, and the clamping pieces 5 and 6 are not continuous with the boundaries of the connecting piece 9 and the attachment pieces 7 and 8, so that the clamping pieces 5 and 6 do not interfere with the bending molding when the molding to be bent at the boundaries of the connecting piece 9 and the attachment pieces 7 and 8 is performed. Therefore, even the knuckle bracket 4 having a shape in which a three-plane intersection point with the clamping pieces 5 and 6, the attachment pieces 7 and 8, and the connecting piece 9 is formed can be molded without difficulty. It is also conceivable to incline the upper surfaces of the clamping pieces 5 and 6 so that the axial length becomes shorter toward the tip end side in the circumferential direction of the clamping pieces 5 and 6 so that the clamping pieces 5 and 6 do not interfere with the bending molding. However, in a case where the upper surfaces are inclined in this manner, it is difficult to mold the clamping pieces 5 and 6 and the weld length may be shortened as compared with the case where the upper surfaces are not inclined.

When the curved inner peripheral surfaces of the clamping pieces 5 and 6 in the knuckle bracket 4 thus obtained abut on the outer peripheral surface of the outer shell 2, the side surface of the horizontal connecting piece 9 orthogonal to the axial direction of the outer shell 2 abuts on the outer peripheral surface of the outer shell 2.

Then, the knuckle bracket 4 is fixed to the outer shell 2 by arc-welding the outer shell 2 from the tip end side of the upper end of the clamping piece 5 to the tip end side of the upper end of the clamping piece 6 on the opposite side via the upper side of the side surface of the connecting piece 9, and arc-welding the tip end of each of the clamping pieces 5 and 6 to the outer periphery of the outer shell 2 along the axial direction.

As described above, in the shock absorber D of the present embodiment, a C-shaped welded portion B1 is formed from a vicinity of the opposite attachment piece side end of the upper end of the clamping piece 5 via the upper side of the connecting piece 9 to a vicinity of the upper end of the opposite attachment piece side end of the clamping piece 6 opposite to the attachment piece side, and a linear welded portion B2 is formed along the axial direction of the outer shell 2 from a vicinity near the upper end to near the lower end of the opposite attachment piece side end of each clamping pieces 5 and 6. The welded portions B1 and B2 are formed by melting the material to be welded and the welding material of the knuckle bracket 4 and the outer shell 2.

In the knuckle bracket 4, the upper ends and the opposite attachment piece side ends of the clamping pieces 5 and 6, and the connecting piece 9 are welded to the outer periphery of the outer shell 2 and attached to the outer shell 2, so that the clamping pieces 5 and 6 are firmly fixed to the outer shell 2 even if the clamping pieces 5 and 6 do not surround the periphery of the outer shell 2 unlike the holding portion of the conventional knuckle bracket.

In addition, the knuckle bracket 4 includes the connecting piece 9 that connects the upper ends of the attachment pieces 7 and 8, and since the attachment pieces 7 and 8 and the connecting piece 9 form a box shape, high strength can be realized, and the knuckle bracket 4 can sufficiently withstand various loads such as bending, shearing, and pulling input from the knuckle that supports the wheel of the vehicle.

As described above, in order to obtain the high-strength knuckle bracket 4, the connecting piece 9 connecting the upper ends from the bases of the clamping pieces 5 and 6 at the upper ends of the attachment pieces 7 and 8 is indispensable. However, in a case where the notches 10 and 11 are not provided, the three-plane intersection point, which is the intersection point of the three surfaces of the clamping pieces 5 and 6, the attachment pieces 7 and 8, and the connecting piece 9, remains in the base material, and it is difficult to bend the attachment pieces 7 and 8 at a right angle with respect to the connecting piece 9, and it is very difficult to mold the knuckle bracket 4. However, in the shock absorber D of the present embodiment, since the knuckle bracket 4 includes the notches 10 and 11 that cut off the three-plane intersection points where the clamping pieces 5 and 6, the attachment pieces 7 and 8, and the connecting piece 9 intersect, the knuckle bracket 4 in which the clamping pieces 5 and 6 do not interfere with the bending molding when the bending molding is performed at the boundary between the connecting piece 9 and the attachment pieces 7 and 8 can be molded without difficulty.

As described above, the shock absorber D according to the present embodiment includes the shock absorber main body 1 having the cylindrical outer shell 2 and the rod 3 movably inserted into the outer shell 2, and the knuckle bracket 4 attached to an outer periphery of a lower end of the outer shell 2, in which the knuckle bracket 4 is formed by bending a single metal plate as a base material and includes the pair of clamping pieces 5 and 6 that are curved along the outer periphery of the outer shell 2 and clamp the outer shell 2, the pair of attachment pieces 7 and 8 that extend in a radial direction of the outer shell 2 from ends in a circumferential direction of the respective clamping pieces 5 and 6 and face each other, the connecting piece 9 that connects ends of the attachment pieces 7 and 8, and the pair of notches 10 and 11 that cut off the three-plane intersection point where the clamping pieces 5 and 6, the attachment pieces 7 and 8, and the connecting piece 9 intersect.

In the shock absorber D configured as described above, even if the clamping pieces 5 and 6 of the knuckle bracket 4 do not surround the outer periphery of the outer shell 2, the knuckle bracket 4 can be firmly fixed to the outer shell 2, and since the attachment pieces 7 and 8 and the connecting piece 9 form a box shape, the strength of the knuckle bracket 4 can be increased to withstand the load input from the knuckle. Since the knuckle bracket 4 includes the pair of notches 10 and 11 for cutting off the three-plane intersection point where the clamping pieces 5 and 6, the attachment pieces 7 and 8, and the connecting piece 9 intersect, the knuckle bracket 4 having high strength can be firmly fixed to the outer shell 2 and can be molded without difficulty.

Since the knuckle bracket 4 does not include a holding portion surrounding the outer shell 2 unlike the conventional knuckle bracket, the knuckle bracket 4 is smaller in size than the conventional knuckle bracket. Therefore, the material required for manufacturing is reduced, and the weight is also reduced.

As described above, according to the shock absorber D of the present embodiment, it is possible to use the small and lightweight knuckle bracket 4, so that the material yield regarding the manufacturing of the knuckle bracket 4 is improved, and thus, it is possible to reduce the cost related to the manufacturing of the shock absorber D and the overall weight of the shock absorber D.

Note that, as described above, the knuckle bracket 4 has a structure in which the upper ends of the attachment pieces 7 and 8 are connected by the connecting piece 9. However, in a case where the lower ends of the attachment pieces 7 and 8 are connected by the connecting piece, the notches 10 and 11 may be provided to cut off a three-plane intersection point where the clamping pieces 5 and 6 intersect the connecting piece at the lower ends of the attachment pieces 7 and 8.

In addition, in the shock absorber D of the present embodiment, since the notches 10 and 11 are rectangular and the corner portions are chamfered in a round surface shape, it is possible to alleviate stress concentration when a load is input from the knuckle to the knuckle bracket 4 by providing the notches 10 and 11.

Note that the width dimension and the length dimension of the notches 10 and 11 can be arbitrarily designed as long as the three-plane intersection point can be cut off, but may be designed in consideration of a die life and maintainability of punching a flat plate having a shape obtained by developing the knuckle bracket 4 illustrated in FIG. 5(a) without causing a significant decrease in the strength of the knuckle bracket 4.

Furthermore, in the shock absorber D of the present embodiment, the notches 10 and 11 in the knuckle bracket 4 are provided to be cut across three surfaces of the clamping pieces 5 and 6, the attachment pieces 7 and 8, and the connecting piece 9. According to the shock absorber D configured as described above, it is possible to prevent the clamping pieces 5 and 6, the attachment pieces 7 and 8, and the connecting piece 9 from inhibiting the deformation of the counterpart, and thus, it is possible to effectively prevent the spring back of the knuckle bracket 4 after molding.

The shapes and dimensions of the attachment pieces 7 and 8 and the connecting piece 9 of the knuckle bracket 4 can be appropriately designed and changed according to the outer diameter of the outer shell 2, the shape of the knuckle of the vehicle, and the like as long as the above-described effects are not lost. In addition, the tip ends of the clamping pieces 5 and 6 in the circumferential direction can protrude even if the tip ends extend to one side opposite to the attachment piece side beyond a half of the outer shell 2 as long as welding to the outer shell 2 is not hindered. However, since the outer shell 2 cannot be inserted between the clamping pieces 5 and 6 from the side while the weight of the clamping pieces 5 and 6 increases, it is preferable that the tip ends of the clamping pieces 5 and 6, which are opposite attachment piece side ends in the circumferential direction do not exceed a half of the outer shell 2 as viewed from the axial direction of the outer shell 2. The length in the axial direction of the outer shell 2 at the tip ends in the circumferential direction of the clamping pieces 5 and 6 can be appropriately designed and changed according to the bonding strength required in the specification.

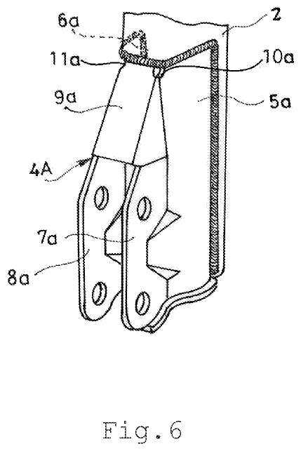

In addition, as illustrated in FIG. 6, a knuckle bracket 4A may have a structure in which clamping pieces 5a and 6a and attachment pieces 7a and 8a are extended upward with respect to the knuckle bracket 4, and a connecting piece 9a is in an inclined posture with respect to the outer shell 2. Even in the knuckle bracket 4A configured as described above, by providing notches 10a and 11a for cutting off the three-plane intersection points of the clamping pieces 5a and 6a, the attachment pieces 7a and 8a, and the connecting piece 9a, the knuckle bracket 4A can be firmly fixed to the outer shell 2 and can be easily molded without difficulty, and high strength can be realized. Therefore, according to the shock absorber using the knuckle bracket 4A configured as described above, the material yield is improved with respect to the manufacturing of the knuckle bracket 4A, so that the cost related to the manufacturing of the shock absorber and the overall weight of the shock absorber can be reduced.

Although the preferred embodiment of the present invention has been described above in detail, modifications, variations, and changes can be made thereto without departing from the claims.

### REFERENCE SIGNS LIST

1 Shock absorber main body
2 Outer shell

### 3 Rod

4, 4A Knuckle bracket
5, 5a, 6, 6a Clamping piece
7, 7a, 8, 8a Attachment piece
9, 9a Connecting piece

### 10, 10a, 11, 11a Notch

D Shock absorber

1. A shock absorber comprising:
a shock absorber main body having a cylindrical outer shell and a rod movably inserted into the outer shell; and
a knuckle bracket attached to an outer periphery of a lower end of the cylindrical outer shell, wherein
the knuckle bracket includes
a single metal plate as a base material,
a pair of clamping pieces that are curved along an outer periphery of the cylindrical outer shell and clamp the cylindrical outer shell,
a pair of attachment pieces that extend in a radial direction of the cylindrical outer shell from ends in a circumferential direction of the respective clamping pieces and face each other,
a connecting piece that connects upper ends or lower ends of the attachment pieces, and
a pair of notches that cut off a three-plane intersection point where the clamping piece, the attachment piece, and the connecting piece intersect.

2. The shock absorber according to claim 1, wherein
the notch has a rectangular shape, and corner portions are chamfered in an R surface shape.

3. The shock absorber according to claim 1, wherein
the notch is provided to be cut across three surfaces of the clamping piece, the attachment piece, and the connecting piece.
